(19) United States
(12) Patent Application Publication
(10) Pub. No.: US 2026/0213624 A1
(43) Pub. Date: Jul. 23, 2026

(54) PUMP DEVICE WITH INTEGRATED SAFE TORQUE OFF FUNCTION

(71) Applicant: Grundfos Holding A/S, Bjerringbro (DK)

(72) Inventors: Mikal Jesper NIELSEN, Bjerringbro (DK); Sergio Filipe do Vale Guimaraes TELES, Eschborn (DE); Jens Uwe MARGGRANDER, Eschborn (DE)

(21) Appl. No.: 19/137,144

(22) PCT Filed: Dec. 13, 2023
(86) PCT No.: PCT/EP2023/085498

§ 371 Date: Jun. 9, 2025

(30) Foreign Application Priority Data
Dec. 15, 2022 (DK) PA202270617

(51) Int. Cl. H02K 11/20; F04D 25/06; F04D 27/00; H02K 5/04; H02K 7/00; H02K 7/14

(52) U.S. Cl. CPC H02K 11/20; F04D 25/06; F04D 27/008; H02K 5/04; H02K 7/003; H02K 7/14

(57) ABSTRACT

A pump device comprising a rotational pump mechanism (P) arranged for pumping a fluid between a fluid inlet and a fluid outlet, and with an electric motor (MT) arranged to rotate a shaft connected to rotate the rotational pump mechanism (P). A motor drive (MD) is connected to the electric motor MT for driving the electric motor (MT) according to a variable frequency drive scheme. A safety circuit (STO) is connected to the motor drive (MD) and with first and second electric inputs (I1, I2) for connection to external electric switches (SW1, SW2). The safety circuit (STO) can enter a Safe Torque Off state causing the motor MT to stop generating torque, and safety circuit (STO) is designed with a redundancy to enter the Safe Torque Off state also in case of a fault, preferably complying with EN ISO 13849-1:2015, category 3. A housing (H) forms an enclosure in which the motor drive (MD) and the safety circuit (STO) are positioned. The housing (H) is attached to the electric motor MT, e.g. to a conductive motor casing of the electric motor (MT). The housing (H) may encircle partly of fully the electric motor (MT) and pump mechanism (P). The pump device provides a compact pump device with integrated safe function which allows for easy installation in applications with safety requirements, and further the pump device allows quick restart after safe mode.

### FIELD OF THE INVENTION

The present invention relates to the field of pump devices, more specifically to the field of pumps driven by an electric motors. Especially, the invention relates to a pump device with an integrated safety function. More specifically, the invention provides a pump device with a integrated safe torque off function.

### BACKGROUND OF THE INVENTION

Pump devices driven by electric motors are used in a wide range of applications and in a variety of sizes. For a number of applications, the pump is operated in environments where the safety of a person can be challenged, if the person comes near the pump or other equipment driven by the pump. Here, safety requirements e.g. prescribe that a set of electric switches must be used to detect if a door is opened during operation of the pump, and in that case the pump should stop functioning.

Such safety stop can be implemented by disconnecting electric power supply to the electric motor driving the pump, such as the with a motor in the electric power range of such as 1-50 kW. However, this will in general cause a time consuming restart of the pump after a safety stop, e.g. for rebooting the motor controller. This may be unacceptable for applications of the pump device, where many such safety stops can be expected.

Other implementations of safety functions exist, e.g. living up to the requirements in IEC 61508-1:2010, Safety Integrity Level (SIL) 3, following the guidelines of EN ISO 13849-1:2015 for Performance Level e, category 3 regarding a Safe Torque Off circuit with sub-function. However, such solutions are bulky since they require a larger number of space requiring components such as a minimum of two optocouplers for electric isolation. Therefore, such solutions are implemented as a separate components connected to a specific application of the pump device.

### OBJECT OF THE INVENTION

It may be seen as an object of the present invention to provide a versatile pump device which can be used in a variety of applications including applications requiring safe mode functions.

### SUMMARY OF THE INVENTION

A first aspect of the invention provides a pump device comprising
a rotational pump mechanism arranged for pumping a fluid between a fluid inlet and a fluid outlet,
an electric motor arranged to rotate a shaft, wherein the shaft is connected to rotate the rotational pump mechanism,
a motor drive connected to the electric motor and being arranged for driving the electric motor according to a variable frequency drive scheme,
a safety circuit connected to the motor drive and with first and second electric inputs arranged for connection to respective first and second external electric switches or contacts, wherein the safety circuit is arranged to enter a Safe Torque Off state causing the electric motor to stop generating torque, and wherein the safety circuit is designed with a redundancy to enter the Safe Torque Off state also in case of a fault, and
a housing forming an enclosure in which the motor drive and the safety circuit are positioned, wherein the housing is attached to the electric motor.

Such pump device is advantageous, since it can be used in a variety of applications, where a safety function is required, this being a safety function to provide a safe mode with a stop or torque off function of the pump device in connecting with opening of a door or port, a light fence, a light guard with a proximity sensor or the like. The pump devices with such integrated safety function can be directly connected to safety switches or contacts already implemented as part of an application without requiring any further pump or motor specific requirements to be accounted for in the specific application.

This facilitates installation of the pump device into applications with safety requirements. No further safety circuit is required to be installed between the safety switches/contacts and the pump device. The pump device may be implemented with electric terminals for connection to the safety switches/contacts on an outer surface of the housing for easy installation.

In preferred implementations, the Safe Torque Off circuit complying with EN ISO 13849-1:2015, category 3 can be implemented with only one single optocoupler, which saves space compared to prior art solutions requiring at least two optocouplers. Thus, the pump device is suited also in version with compact dimensions.

Further, compared to safety functions where supply power to the pump device is completely cut off in safe mode, the proposed solutions with a Safe Torque Off circuit allows a short start up time of the pump device, which is important for a number of applications. This is obtained with the Safe Torque Off circuit which allows power supply to the electric motor, including motor control functions, during safe mode, and therefore a completed motor control reboot of the pump device at start up is eliminated.

In the following, preferred features and embodiments will be described.

Preferably, the safety circuit is arranged to comply with requirements of a Safe Torque Off safety sub-function according to IEC 61800-5-2:2016, preferably also EN ISO 13849-1:2015, category 3. This provides a high degree of safety with a fail safe function.

Preferably, the safety circuit comprises at least one electric isolator component serving to electrically isolate the first and second electric inputs from the motor drive. Especially, the at least one electric isolator component may be implemented by one single optocoupler. It is especially found possible to implement a Safe Torque Off circuit complying with EN ISO 13849-1:2015, category 3, where only one single optocoupler can be used, thereby saving space compared to known solutions.

More specifically, the safety circuit may comprise a pulse generator and a modulator, and wherein an output from the modulator is connected to an input of the single optocoupler. More specifically, the pulse generator is preferably connected to the second electric input and being arranged to generate an oscillating electric output voltage at an output when powered from the second electric input. More specifically, the pulse generator may be arranged to generate an output voltage switching between two levels. Even more specifically, the pulse generator may be arranged to oscillate at a frequency of 1-100 kHz, such as 10-20 kHz, such as 14-16 kHz, between the two output voltage levels. Especially, the pulse generator may be arranged to generate an output voltage switching between a DC voltage and electrical ground (zero V). Such DC voltage may be of 1-50 V, such as 10-40 V, such as 20-30 V. In a preferred implementation, the pulse generator being arranged to oscillate between 24 V and 0 V. The modulator may be connected to the first electric input and the output of the pulse generator, wherein the modulator is arranged to generate an electric output signal being a modulated version of an electric voltage at the first input at a rate defined by the pulse generator.

In preferred embodiments, the safety circuit comprises first and second logic comparator blocks both being arranged to receive an electric output signal from the electric isolator component and to provide respective first and second logic outputs accordingly. Especially, each of the first and second logic comparator blocks comprises a pulse detector connected to receive said electric output signal from the electric isolator component, and wherein the first and second logic comparator blocks are arranged to generate the respective first and second logic outputs in accordance with outputs of the respective pulse detectors. Especially, the first and second logic comparator blocks may be connected to gate respective high and low gate driver outputs for driving respective high and low gate driver parts of the motor drive according to the first and second logic outputs. Specifically, this is done so as to drive both of high and low gate driver parts of the motor drive only in case both of the first and second pulse detection outputs indicate that a pulse signal is detected by both of the first and second pulse detectors. More specifically, respective first and second logic gates, such as AND gates, may be arranged to receive the respective first and second logic outputs and gate respective high and low gate driver outputs accordingly for driving respective high and low gate driver parts of the motor drive. In some versions for a one-phase electric motor, the high and low gate driver outputs can be implemented for one-phase only. In versions for a three-phase electric motor, each of the high and low gate driver outputs comprises three electric phases.

In some implementations, the safety circuit is implemented on one circuit board and connected to an input of an electric isolator component, such as an optocoupler, which is implemented on another circuit board along with components forming the motor drive. However, if preferred, both of the safety circuit and components forming the motor drive may be implemented on one circuit board.

The electric motor may be arranged for connection to an AC electric power source, e.g., an AC electric power source providing a 100 V AC to 500 V AC electric power input, e.g., the public grid. In some embodiments, e.g. for solar powering, the pump device may be configured to receive an electric power input in the form of a DC voltage, e.g. in the form of a positive and a negative DC voltage.

The electric motor may be any known electric motor technology involving a stator and a rotor to allow rotation of a shaft. The electric motor may be a permanent magnet electric motor, however the electric motor is not limited to that.

The rotational pump mechanism may be based on any known pump technology. E.g., the rotational pump mechanism may comprise an impeller arranged to rotate inside an impeller housing for pumping fluid, e.g., liquid such as water, from a fluid inlet to a fluid outlet, upon rotation.

The housing may in some embodiments extend around the rotational pump mechanism, such as being partly or fully integrated with an electrically conductive motor housing. The housing is preferably made of a composite another electrically non-conductive material. material, however other materials can be used. The housing may have, in its interior part, an electric isolation layer.

The housing may enclose all electronic components of the pump device. The housing preferably has openings to allow electric connection to an electric power source, e.g. it may have pipe connections for fluid inlet and fluid outlet.

The housing preferably has an opening to allow external access to the first and second electric inputs of the safety circuit.

It is to be understood that the invention is applicable to pump devices of various sizes. E.g., pumps with electric motors in the electric power range of 1 W to 100 W, however also to pump devices with electric motors in the electric power range 100 W to 1 kW, or larger pumps in the power range of 1-50 kW or even more.

The skilled person will know how to implement the invention based on the disclosure of the present description and the general knowledge in the technical field.

In a second aspect, the invention provides a system comprising
a pump device according to the first aspect, and
first and second switches or contacts connected to the first and second electric inputs of the safety circuit.

Such system can be implemented in many applications, where a safety function is required. The pump devices with such built-in safety function is highly versatile, since it can be directly connected to safety switches or contacts already implemented as part of an application without requiring any further pump specific requirements.

In specific examples, the first and second electric contacts may be positioned to detect opening of a door or port. Especially, the first and second electric contacts may form part of as an emergency stop. Especially, the first and second electric contacts may implemented as part of a light fence. Especially first and second electric contacts may be implemented as part of a light guard comprising a proximity sensor.

More specifically, the system may comprise a control system to control a function of the one or more pump devices. Specifically, the system may be a utility installation, e.g., a water, heat, or cooling installation.

In a third aspect, the invention provides use of the pump device according to any of the first aspect. Specifically, the use may be for an application being one of: a horizontal mounted multi-stage end-suction pump, a horizontal mounted single-stage end-suction pump, a vertically mounted multi-stage pump, a vertically mounted single-stage pump, a biobooster filter module, a washing or cleaning equipment, a stable ventilation, an industrial ventilation, a transport system, a process system, gears, hydraulics, a machine, and machine tool.

The mentioned aspects of the present invention may be combined. These and other aspects of the invention will be apparent from and elucidated with reference to the embodiments described hereinafter.

### BRIEF DESCRIPTION OF THE FIGURES

The pump device according to the invention will now be described in more detail with regard to the accompanying figures. The figures show one way of implementing the present invention and is not to be construed as being limiting to other possible embodiments falling within the scope of the attached claim set.

FIG. 1 shows a diagram of components of a pump device embodiment, and

FIG. 2 shows a diagram of a preferred Safe Torque Off circuit to be integrated in the housing of the pump device.

### DETAILED DESCRIPTION OF AN EMBODIMENT

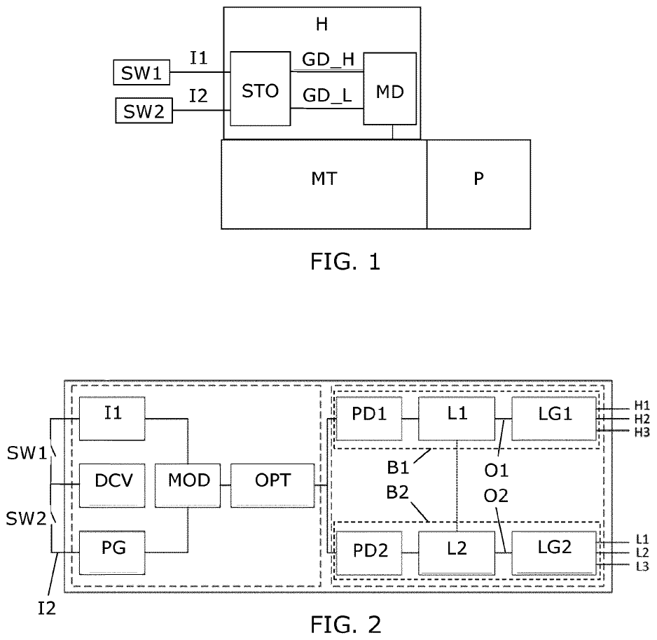

FIG. 1 shows a block diagram of a pump device embodiment comprising a rotational pump mechanism P arranged for pumping a fluid between a fluid inlet and a fluid outlet. An electric motor MT is arranged to rotate a shaft, and the electric motor MT is mounted to rotate the rotational pump mechanism. The electric motor MT has a motor drive MD connected to drive the electric motor according to a variable frequency drive scheme.

Further, the pump device comprises a safety circuit STO, preferably a Safe Torque Off circuit, connected to the motor drive MD and with first and second electric inputs I1, I2 arranged for connection to respective first and second external electric switches or contacts SW1, SW2, e.g. connected to detect opening of a door or port, or other safety detection functionalities. The purpose of the circuit STO is to provide a safety function of the electric motor MT, which causes the electric motor MT to stop generating torque in case one of the switches SW1, SW2 is detected to be closed, thereby also stopping rotating the pump mechanism P. The safety circuit STO is arranged to enter a Safe Torque Off state causing the motor MT to stop generating torque, and wherein the safety circuit STO is designed with a redundancy to enter the Safe Torque Off state also in case of a fault. In the most preferred embodiments, safety circuit STO is so as to comply with the requirements in EN ISO 13849-1:2015, category 3, requiring a fault safe operation of the Safe Torque Off circuit STO.

The Safe Torque Off circuit STO is connected to the motor drive MD of the electric motor MT. More specifically, the Safe Torque Off circuit STO is preferably arranged to gate outputs GD_H, GD_L to the motor drive MD for driving respective high and low gate driver parts of the motor drive MD. Thus, the Safe Torque Off circuit STO can manipulate both the high and the low gate driver signals to the motor drive MD to cause the motor to stop generating torque, if the Safe Torque Off circuit STO detects close of any one of the safety switches SW1, SW2.

A housing H forms an enclosure in which the motor drive MD and the safety circuit STO are positioned. Especially, the safety circuit STO and the motor drive MD may be implemented partly of fully integrated, e.g. with electric components share on the same circuit board.

The housing H is attached to the electric motor MT, preferably attached to an electrically conductive casing of the motor MT, so as to partly of fully encircle the electrically conductive casing of the motor. Further, the housing H may partly or fully encircle the pump mechanism P. Preferably, the housing H provides external access to the first and second electric inputs I1, I2 of the safety circuit STO, to allow easy connection to external safety electric switches or contacts SW1, SW2. In this way, the pump device is highly suited for easy use in applications requiring a safety functionality.

In preferred implementations of the safety circuit STO, to be explained in the following, the safety circuit STO can be implemented with a minimum amount of bulky components, which allows the housing H to be compact. Still, the safety circuit STO can be implemented so that the pump P can be re-started quickly after a safe mode stop, since using a Safe Torque Off circuit STO, electric power can be kept on to all components controlling the electric motor MT, including the motor drive MD and any control function with software. Thereby, a reboot of the motor control is eliminated in safe mode, which allows a fast start up time after safe mode stop.

The pump device is advantageous, since the safety function is provided as an integrated part of the pump device. This allows easy installation of the pump device in application where a safety function is required without the need to have an external safety circuit which may typically require a complete power off of the pump device in safe mode.

FIG. 2 shows a preferred safety circuit, namely a Safe Torque Off circuit STO which is functionally illustrated with a block diagram serving to explain the function of the circuit. The circuit has two electric inputs I1, I2. These input I1, I2 are connected to two safety switches SW1, SW2. As seen, the two switches SW1, SW2 are interconnected at a midpoint which is connected to a fixed DC voltage DCV, e.g. 10-30 V, e.g. 24 V from a voltage supply, and this voltage DCV may be used in general as supply for the electric components of the Safe Torque Off circuit STO.

A pulse generator PG is connected to the second electric input I2 and being arranged to generate an oscillating electric output voltage, oscillating at 15 kHz between electric ground (zero V) and 24 V when powered from the second electric input I2.

A modulator MOD is connected to the first electric input I1 and the output of the pulse generator PG, and the modulator MOD generates an electric output signal being a modulated version of an electric voltage at the first input I1 at a rate defined by the pulse generator PG controlled by the second input I2.

An electric isolator component, e.g. an optocoupler OPT, is connected to receive the electric output signal from the modulator MOD and being arranged to generate an electric output signal accordingly which is electrically isolated from the electric output signal from the modulator MOD.

First and second logic comparator blocks B1, B2 are both being arranged to receive the output from the optocoupler OPT and to provide respective first and second logic outputs O1, O2 accordingly.

Each of the two logic comparator blocks B1, B2 comprises a pulse detector PD1, PD2 connected to receive the output from the optocoupler OPT and being arranged to generate the respective logic outputs O1, O2 in accordance with outputs of the respective pulse detectors. The pulse detectors PD1, PD2 provide logic outputs indicating if pulses are received or not.

First and second interconnected logic comparators L1, L2 are arranged to receive the respective outputs from the first and second pulse detectors PD1, PD2. These logic comparators L1, L2 are arranged to compare signals from the pulse detectors PD1, PD2 with approval limits, and if just one of the comparators L1, L2 detects an error, it is interconnected with the other one of the comparators L1, L2 such that both of the logic outputs O1, O2 will indicate an error, and thus even a failure in one of the pulse detectors PD1, PD2 will cause both logic outputs O1, O2 to indicate an error.

Hereby, it can be ensured to drive both of the high and low gate driver parts of the motor drive only in case both of the first and second logic outputs O1, O2 indicate that a pulse signal is detected by both of the first and second pulse detectors PD1, PD2. Thus, the interconnection between the logic comparators L1, L2 ensures a fail safe function even though only one single input signal from the single optocoupler OPT is provided to the logic comparator blocks B1, B2.

Finally, first and second logic gates LG1, LG2 receive the respective logic outputs O1, O2 and these logic gates LG1, LG2 are arranged to allow the respective high and low gate driver outputs (H1, H2, H3, L1, L2, L3) to pass for driving respective high and low gate driver parts of the motor drive, e.g. an IGBT based motor drive. The logic gates LG1, LG2 are preferably implemented by AND gates.

In the illustrated case three high gate driver outputs H1, H2, H3 and three low gate driver outputs L1, L2, L3 are generated to be connected to the three-phase motor drive for driving a three-phase electric motor. In case of a one-phase electric motor and motor drive, only a single output is generated for the respective high and low gate driver parts.

The skilled person will know how to implement the functional blocks illustrated and described in connection with FIG. 2 by means of electric circuits. All elements can be implemented by simple electric components occupying only a small amount of space and can be implemented at low cost.

The safety compliance EN ISO 13849-1:2015, category 3 can be obtained by the use of one single optocoupler as electric isolator component. An optocoupler is a bulky component to fit into the housing of compact device. Thus, the implementation of the safety function with one single optocoupler allows the Safe Function Off circuit to be integrated in the housing H attached to an electric motor MT even at very compact dimensions of the pump device, e.g. down to pump devices with electric motors MT in the electric range of 100 W or the like. However, it is to be understood that the invention is advantageous also for larger pump devices.

The safety circuit STO can preferably be implemented on one circuit board and connected to an input of an optocoupler which is implemented on another circuit board along with components forming the motor drive. However, all of these components may be implemented on one single circuit board, if preferred.

To sum up, the invention provides a pump device comprising a rotational pump mechanism (P) arranged for pumping a fluid between a fluid inlet and a fluid outlet, and with an electric motor (MT) arranged to rotate a shaft connected to rotate the rotational pump mechanism (P). A motor drive (MD) is connected to the electric motor MT for driving the electric motor (MT) according to a variable frequency drive scheme. A safety circuit (STO) is connected to the motor drive (MD) and with first and second electric inputs (I1, I2) for connection to external electric switches (SW1, SW2). The safety circuit (STO) can enter a Safe Torque Off state causing the motor MT to stop generating torque, and safety circuit (STO) is designed with a redundancy to enter the Safe Torque Off state also in case of a fault, preferably complying with EN ISO 13849-1:2015, category 3. A housing (H) forms an enclosure in which the motor drive (MD) and the safety circuit (STO) are positioned. The housing (H) is attached to the electric motor MT, e.g. to a conductive motor casing of the electric motor (MT). The housing (H) may encircle partly of fully the electric motor (MT) and pump mechanism (P). The pump device provides a compact pump device with integrated safe function which allows for easy installation in applications with safety requirements, and further the pump device allows quick restart after safe mode.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. The mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A pump device, comprising:
a rotational pump mechanism (P) arranged for pumping a fluid between a fluid inlet and a fluid outlet,
an electric motor (MT) arranged to rotate a shaft, wherein the shaft is connected to rotate the rotational pump mechanism (P),
a motor drive (MD) connected to the electric motor and being arranged for driving the electric motor (MT) according to a variable frequency drive scheme,
a safety circuit (STO) connected to the motor drive (MD) and with first and second electric inputs (I1, I2) arranged for connection to respective first and second external electric switches or contacts (SW1, SW2), wherein the safety circuit (STO) is arranged to enter a Safe Torque Off state causing the electric motor (MT) to stop generating torque, and wherein the safety circuit (STO) is designed with a redundancy to enter the Safe Torque Off state also in case of a fault, and
a housing (H) forming an enclosure in which the motor drive (MD) and the safety circuit (STO) are positioned, wherein the housing (H) is attached to the electric motor (MT), such as attached to a conductive motor casing of the electric motor (MT).

2. The pump device according to claim 1, wherein the safety circuit (STO) comprises at least one electric isolator component (OPT) serving to electrically isolate the first and second electric inputs (I1, I2) from the motor drive (MD), such as the at least one electric isolator component (OPT) being implemented by one single optocoupler.

3. The pump device according to claim 2, wherein the safety circuit (STO) comprises a pulse generator (PG) and a modulator (MOD), and wherein an output from the modulator (MOD) is connected to an input of the at least one electric isolator component, such as the modulator (MOD) being connected to the first electric input (I1) and the output of the pulse generator (PG), wherein the modulator (MOD) is arranged to generate an electric output signal being a modulated version of an electric voltage at the first electric input (I1) at a rate defined by the pulse generator (PG).

4. The pump device according to claim 3, wherein the pulse generator (PG) is connected to the second electric input (I2) and being arranged to generate an oscillating electric output voltage at an output when powered from the second electric input (I2), such as the pulse generator (PG) being arranged to generate an output voltage switching between two levels, such at the pulse generator (PG) being arranged to oscillate at a frequency of 1-100 kHz.

5. The pump device according to claim 2, wherein the safety circuit (STO) comprises first and second logic comparator blocks (B1, B2) each comprising a pulse detector (PD1, PD2) connected to receive an electric output signal from the at least one electric isolator component (OPT), and wherein the first and second logic comparator blocks (B1, B2) are arranged to generate respective first and second logic outputs (O1, O2) in accordance with outputs of the respective pulse detectors (PD1, PD2), and wherein the first and second logic comparator blocks (B1, B2) are arranged to receive the respective first and second logic outputs (O1, O2) and gate respective high and low gate driver outputs (L1, L2, L3, H1, H2, H3) accordingly for driving respective high and low gate driver parts of the motor drive (MD).

6. The pump device according to claim 5, wherein the first and second logic comparator blocks (B1, B2) are arranged to drive both of the high and low gate driver parts of the motor drive (MD) only in case both of the first and second pulse detection outputs (O1, O2) indicate that a pulse signal is detected by both of the first and second pulse detectors (PD1, PD2).

7. The pump device according to claim 5, wherein each of the high and low gate driver outputs comprises three electric phases.

8. The pump device according to claim 1, wherein the safety circuit (STO) is implemented on one circuit board and connected to an input of an electric isolator component (OPT), such as an optocoupler, which is implemented on another circuit board along with components forming the motor drive (MD).

9. The pump device according to claim 1, wherein both of the safety circuit (STO) and components forming the motor drive (MD) are implemented on one circuit board.

10. A system, comprising:
a pump device according to claim 1, and
first and second switches or contacts (SW1, SW2) connected to the first and second electric inputs (I1, I2) of the safety circuit (STO), such as first and second electric contacts positioned to detect opening of a door or port, such as an emergency stop, such as a light fence, such as a light guard comprising a proximity sensor.

11. The pump device according to claim 4, wherein the frequency is 10-20 kHz.

12. The pump device according to claim 4, wherein the frequency is 14-16 kHz.
